(19) United States
(12) Patent Application Publication
(10) Pub. No.: US 2009/0177395 A1
(43) Pub. Date: Jul. 9, 2009

(54) Navigation device and method

(76) Inventor: David Stelpstra, Amsterdam (NL)

Correspondence Address: TOMTOM INTERNATIONAL B.V., REMBRANDTPLEIN 35, AMSTERDAM, 1017CT, NL

(21) Appl. No.: 12/007,137

(22) Filed: Jan. 7, 2008

(51) Int. Cl. G01C 21/00

(52) U.S. Cl. 701/213

(57) ABSTRACT

A method of determining the position of a navigation device when only relatively poor GPS signals are available is described, together with a navigation device capable of determining its current location in such conditions. The method comprises the steps of receiving a plurality of GPS signals from a plurality of GPS satellites, determining range information from timing information forming part of said signals, together with identification information, specific to each of said satellites, attempting to receive and store the entire ephemeris data payloads additionally forming part of each said signals and being specific to each of said satellites.

### BACKROUND OF THE INVENTION

Portable navigation devices (PNDs) including GPS (Global Positioning System) signal reception and processing means are well known and are widely employed as in-car navigation systems. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favourite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function provided, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that
a user deviates from the previously calculated route during navigation therealong,
real-time traffic conditions dictate that an alternative route would be more expedient and the device is suitably enabled to recognize such conditions automatically, or
if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and taffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Of course, the utility of any PND or navigation system is dependent on receiving GPS signals from most preferably four or more satellites. Under normal operation, the signals transmitted by the satellites are unimpeded by man-made objects and relatively strong, and from the clock pulses forming part of the signal from each satellite, the PND can derive the range of each of those satellites from a calculation of the time taken between transmission and reception of the signals from each of the satellites. Additionally piggybacked on, or otherwise transmitted as part of, the satellite broadcast signals is so-called almanac or ephemeris data including a wide range of satellite specific data, such as satellite global position in a particular coordinate system (e.g. spherical), orbit information and other astronomical and celestial data. It is this information which must be received and decoded by the PND, for each satellite, before any reliable determination of the current location of the PND can be made.

The signals from four satellites are required because there are generally four unknown quantities. The known trilateration technique used to determine the PND location is a series of three equations involving three unknowns, these being the current location coordinates with respect to the three pre-determined reference points on the earth's surface determined from the specific position of the each satellites. The fourth unknown arises from the fact that the clock signals, and thus the transmission times of each of the signals from the satellites, require correction because the atomic clocks within the satellites are offset from the GPS time system by an amount Δt (due to relativistic, drift and other effects), this being substantially the same for all the satellites forming part of the GPS system, but unknown at the PND. Thus, once the satellite ranges are calculated and corrected for time offset, trilateration techniques can be used to determine the current position of the PND.

However, the reception and decoding of the ephemeris data can only occur when the PND is receiving good, unimpeded satellite signals. Furthermore, the ephemeris data is specific to each satellite and only transmitted every 30 s, so in cases where the GPS signals are poor, it may take significantly longer for the PND to successfully receive and decode the entire ephemeris data payload for each satellite from its respective broadcast signal, and thus determine the particular reference points on the earth's surface which are used in the trilateration calculation.

Thus, in locations where relatively poor GPS signals prevail, the PND is only capable of determining satellite range information which is of little use without the additional ephemeris data, and insufficient to make any determination of the current position of the PND. It should be mentioned at this stage that even in areas where only relatively weak GPS signals can be received, the PND is still capable of determining clock pulse and timing information from the received signals, and thus determining the range of the satellites from the PND. Although clock and timing information does form part of the ephemeris data standard, it is substantially segregated from the remainder of the ephemeris data and thus decipherable even when the majority of the data payload is not.

It is an object of the present invention to provide a PND or navigation system, a method of operating such, and a computer program by means of which such are controlled, which enables accurate determination of PND or navigation system current location despite only relatively weak GPS signals being received.

### BRIEF SUMMARY OF THE INVENTION

According to the present invention there is provided a method of determining the position of a navigation device, comprising the steps of Receiving a plurality of GPS signals from a plurality of GPS satellites,

Determining range information from timing information forming part of said signals, together with identification information, specific to each of said satellites,

Attempting to receive and store the entire ephemeris data payloads additionally forming part of each said signals and being specific to each of said satellites,

Characterized by the further steps of

Establishing a communication with a proximate device using a wireless communication protocol,

Determining that the proximate device has already stored the ephemeris data, or specific parts thereof, relating to satellite position, for the identified satellites,

Requesting and receiving said ephemeris data or specific parts thereof for the identified satellites,

Said navigation device subsequently determining its current location using both the range information and the wirelessly received ephemeris data specific to the satellites for which the range information has been determined.

In one embodiment, the establishment of a communication with a proximate device, and the subsequent request for and reception of ephemeris data is conditional on a determination that the navigation device cannot completely receive and store the entire ephemeris data payloads for each of the identified satellites.

In an alternative embodiment, the establishment of a communication with a proximate device, or the attempt to establish such a communication, and the subsequent request for and reception of ephemeris data occurs concurrently and/or unconditionally as the navigation device attempts to completely receive and store the entire ephemeris data payloads for each of the identified satellites. Most preferably, in the case where the navigation device receives satellite signals from more than four satellites, the navigation device determines the four strongest signals and determines and stores range information and identification information only for said four satellites.

Further preferably, after the establishment of the communication between the navigation device and the proximate device, the navigation device interrogates the proximate device to determine whether ephemeris data is available for the four identified satellites for which range information is stored on said navigation device, and on a positive determination thereof, a request is made for the ephemeris data specific to said four satellites.

Most preferably the navigation device receives satellite signals using one type of signal transmission or communication protocol, and communicates with the proximate device using a different protocol, most preferably any of the widely available mobile telecommunications protocols or short-range wireless communications protocols, e.g. GPRS, GSM, CDMA, Bluetooth, Wi-Fi, Wi-Max, UMTS, HSCSD, EDGE, W-CDMA and the like.

In a preferred embodiment, the navigation device only requests and receives specific portions of said ephemeris data relating to the identified satellites, said specific portions of data including information representative of the positions of the said identified satellites.

In further aspects of the invention, a computer program, embodied on computer readable media as required, is provided for implementing the methods described above, as is a PND and/or navigation system adapted to perform the methods described.

### BRIEF DESCRIPTION OF THE SEVERAL VIEWS OF THE INVENTION

The present application will be described in more detail below by using example embodiments, which will be explained with the aid of the drawings, in which:

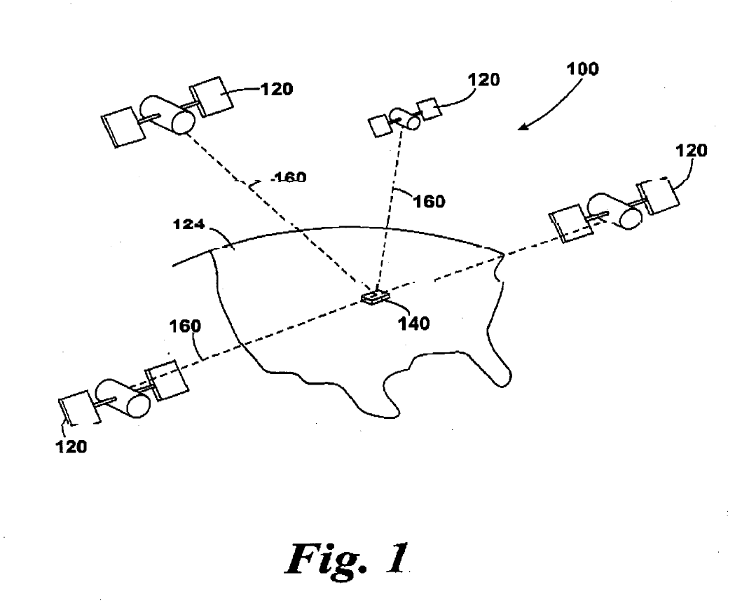

FIG. 1 illustrates an example view of a Global Positioning System (GPS);

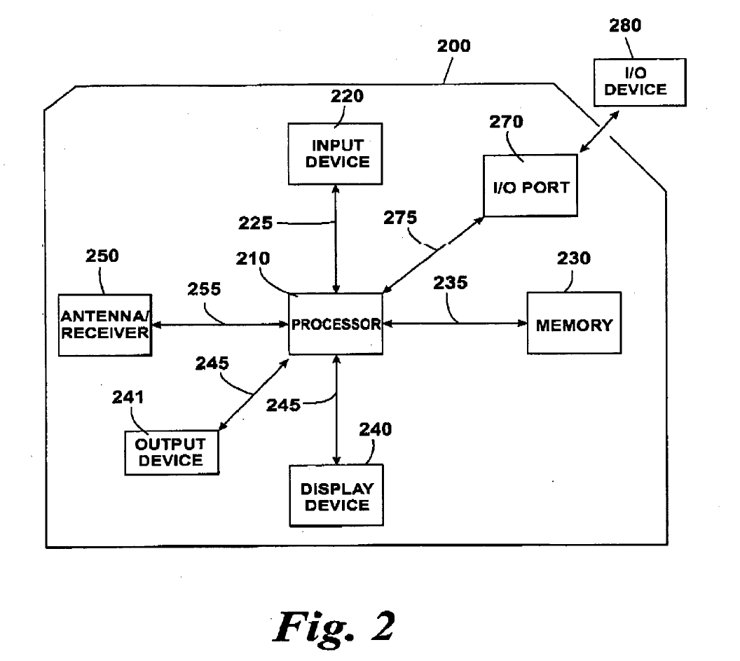

FIG. 2 illustrates an example block diagram of electronic components of a navigation device;

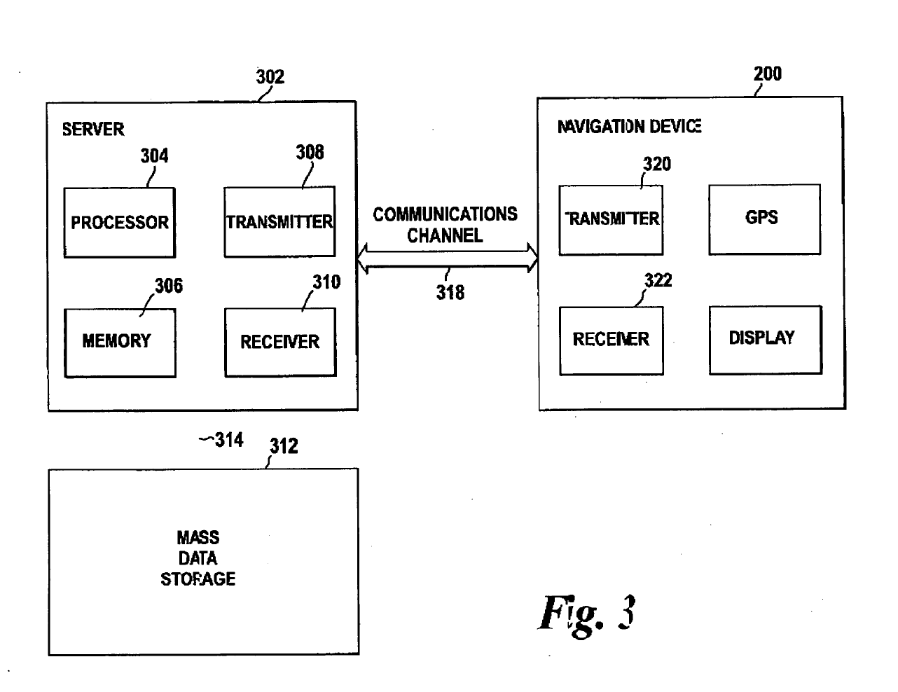

FIG. 3 illustrates an example block diagram of the manner in which a navigation device may receive information over a wireless communication channel;

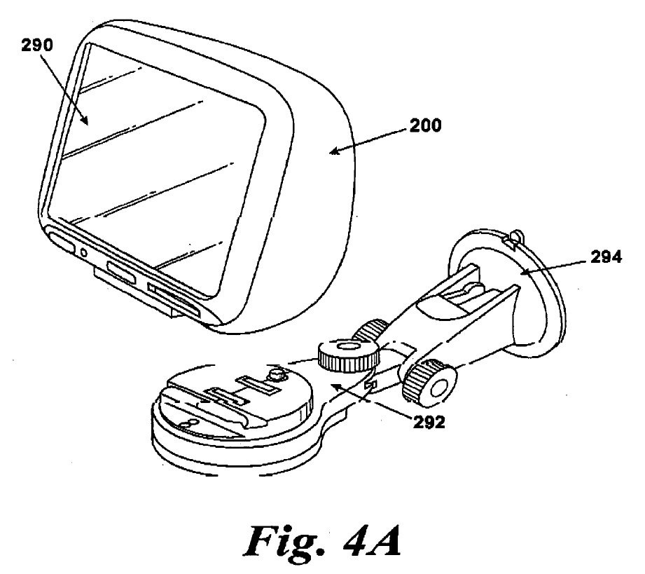

FIGS. 4A and 4B are perspective views of an implementation of an embodiment of the navigation device;

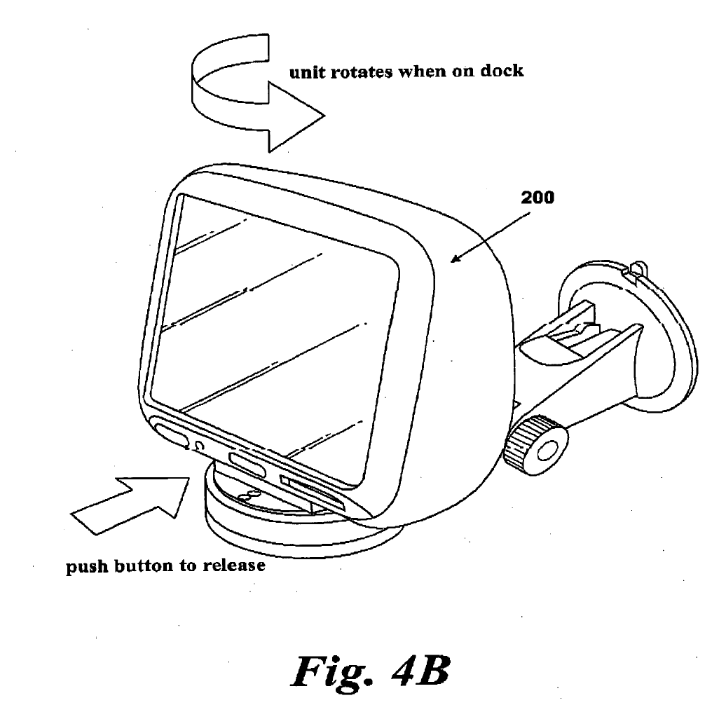

FIG. 5 shows a schematic diagram illustrating the prior art trilateration technique for establishing the position of a device from satellite signals, and

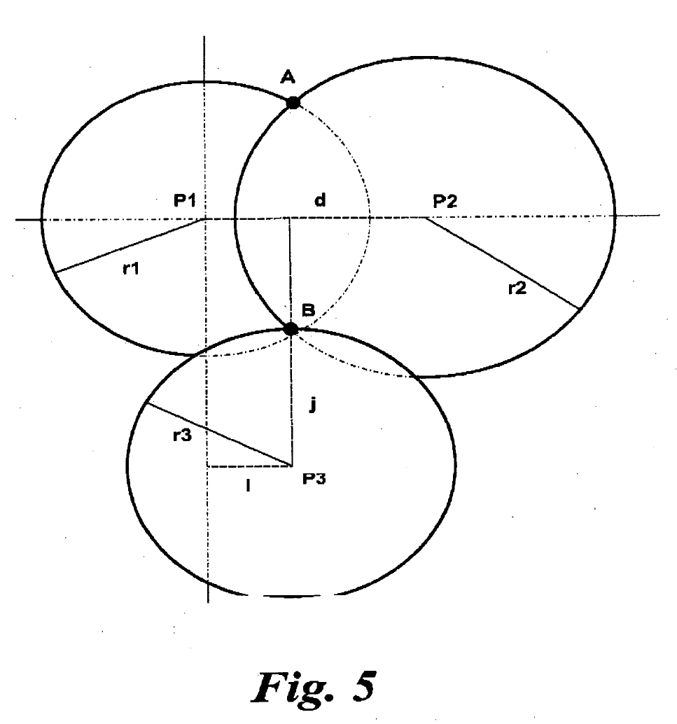

FIG. 6 schematically illustrates the invention wherein a PND can receive both satellite signals and wireless telecommunications signals.

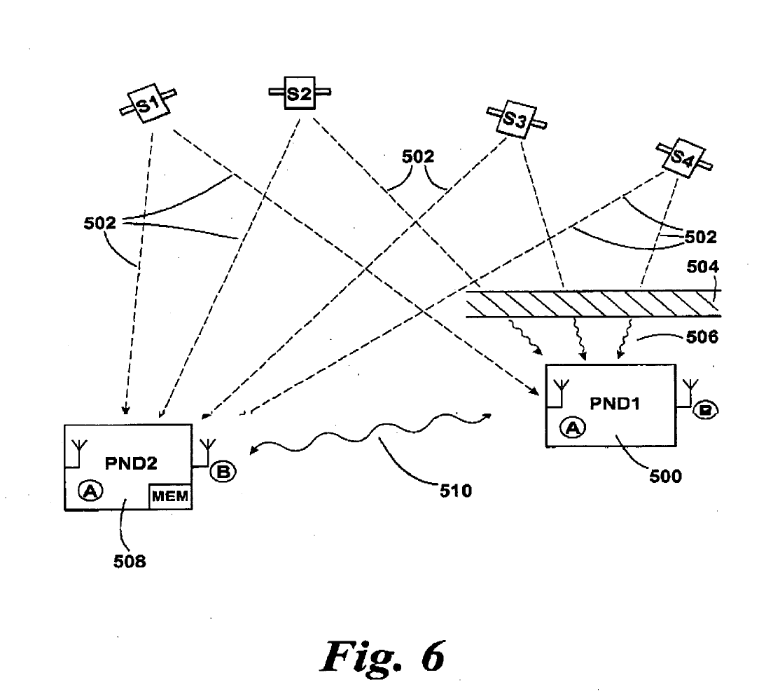

FIG. 7 shows the block diagram of FIG. 2 enhanced by the provision of an additional wireless signal antenna.

### DETAILED DESCRIPTION OF THE INVENTION

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well. In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc. The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

Referring now to FIG. 5, a mathematical derivation for the solution of a three-dimensional trilateration problem can be found by taking the formulae for three spheres and setting them equal to each other. To do this, three arbitrary constraints are applied to the centers of these spheres; all three must be on the z=0 plane, one must be on the origin, and one other must be on the x-axis. It is, however, possible to translate any set of three points to comply with these constraints, find the solution point, and then reverse the translation to find the solution point in the original coordinate system.

Starting with three spheres,

r₁²=x²+y²+z²,

r₂²=(x−d)²+y²+z²,

and

r₃=(x−i)²+(y−y)²+z²,

and subtracting the second from the first and solving for x:

$$x = \frac{{r}_{1}^{2} - {r}_{2}^{2} + {d}^{2}}{2 d}$$

Substituting this back into the formula for the first sphere produces the formula for a circle, the solution to the intersection of the first two spheres:

$${y}^{2} + {z}^{2} = {r}_{1}^{2} - \frac{{( {r}_{1}^{2} - {r}_{2}^{2} + {d}^{2} )}^{2}}{4 {d}^{2}}$$

Setting this formula equal to the formula for the third sphere finds:

$$y = \frac{{r}_{1}^{2} - {r}_{3}^{2} - {x}^{2} + {( x - i )}^{2} + {j}^{2}}{2 j} = \frac{{r}_{1}^{2} - {r}_{3}^{2} + {i}^{2} + {j}^{2}}{2 j} - \frac{i}{j} x$$

Now that the x- and y-coordinates of the solution point are known, the formula can simply be rearranged for the first sphere to find the z-coordinate:

z=\sqrt{r₁²−x²−y²}

This provides a solution to all three points x, y and z. Because z is expressed as a square root, it is possible for there to be zero, one or two solutions to the problem.

This last part can be visualized as taking the circle found from intersecting the first and second sphere and intersecting that with the third sphere. If that circle falls entirely outside of the sphere, z is equal to the square root of a negative number: no real solution exists. If that circle touches the sphere on exactly one point, z is equal to zero. If that circle touches the surface of the sphere at two points, then z is equal to plus or minus the square root of a positive number.

In the case of no solution, a not uncommon one when using noisy data, the nearest solution is zero. It is usual though, to do a “sanity check” and assume zero only when the error is appropriately small.

In the case of two solutions, some technique must be used to disambiguate between the two. This can be done mathematically, by using a fourth sphere (i.e. position data from a fourth satellite, P4) with its center not being located on the same plane as the centers of the other three, and determining which point lies closest to the surface of this sphere. Or it can be done logically-for example, GPS receivers assume that the point that lies inside the orbit of the satellites is the correct one when faced with this ambiguity, because it is generally safe to assume that the user is never in space, outside the satellites' orbits.

Referring to FIG. 6, there is shown a schematic illustrating how a PND (or other navigation system) 500 provided with both a wireless communication signal antenna (e.g. Bluetooth, GPRS) “A” and a GPS antenna “B” for receiving GPS signals from different satellites S1, S2, S3, S4, said signals represented by dotted lines 502 and including both atomic clock data and ephemeris data payloads including a wide variety of satellite specific information, together with other general, celestial, mechanical and astronomical information. As can be seen, the signals from satellites S2, S3, S4 are shown impeded by some form of obstruction 504, which may be for example a building, trees, or other structure. Although some penetration of satellite signals is possible through such some obstructions, as shown at 506, the GPS signals deteriorate markedly when passing through such obstructions, if indeed they penetrate them at all. In cases where such GPS signals can be detected by the PND, generally it is not possible to decode or derive the entire ephemeris data payload carried by the signals, but it may be possible to derive range information from the clock pulses contained within the payloads, these recurring more frequently than the payload, which is usually only broadcast every 30 s by the satellites.

Accordingly, in such instances, it is impossible for the PND to obtain a reliable fix on its current location, although it is possible to identify the satellites S1-S4, and to establish their distance, albeit including some systematic error on account of the difference between the atomic clock data carried by the signals and the GPS time system to which the atomic clock data is converted or translated once the error factor, commonly Δt, is determined as a result of subsequent calculations which require at least some of the ephemeris data.

An example of the problem with current PNDs is that it is common for cars, which such devices are most commonly used, to be parked in garages where GPS data is patchy is best. When the device is initially switched on, the GPS antenna feeds whatever signals it receives to associated processing electronics, which, operating under the control of software loaded in the memory of the device, attempts to store one entire ephemeris data payload for each of the GPS signals received from satellites S1-S4. In locations of poor GPS signal transmission, this is not possible, and the device continues to attempt to lock onto each satellite before displaying map information on the display screen of the device pertinent to the current location. This may take some time, at least in excess of 30s, and in many instances, significantly longer, particularly in very built-up areas such as city centres.

However, in accordance with the invention, the device is also provided with a second wireless signal transmission and reception antenna, by means of which a signal 510 is broadcast including a request for communication with any other similarly equipped device in the local vicinity of the device 500. In the Figure, a proximate device PND2 508 receives the broadcast signal 510, detects the request, and subsequently responds appropriately to initiate a communication over the established communication channel.

As can be appreciated from the Figure, the device 508 is capable of receiving unobstructed GPS signals 502 from all the various satellites S1-S4, and has therefore already received relevant ephemeris data payloads and stored this data, or a relevant subset of it, in memory. On receiving a request from the device 500 for this data, in respect of the satellites S1-S4 which have already been identified by the device 500, or those portions of it being required for position determination of the satellites by device 500, said data is transmitted over the communication channel using the appropriate protocol to said device 500. It is to be mentioned that the process of requesting ephemeris data from a proximate device can occur simultaneously or concurrently with the reception, or attempted reception, of GPS data, or may be initiated as a consequence of determining, in device 500, that ephemeris data cannot be currently obtained, or may take longer than 30 s to obtain.

Once the relevant ephemeris data is obtained by device 500, current location calculations can commence, optionally including some correction of the satellite position-specific ephemeris data on account of the displacement of the satellites since that data was received and stored in the device 508.

To explain further, the current location calculations carried out in the devices 500, 508 are fundamentally dependent on the precise determination of the position of the satellites at a particular time. This can only be determined from the ephemeris data sent by the satellite defining the parameters of its orbit, its velocity, and degrees of drift, decline, incline or other progressive deviation from the orbit, and from satellite range measurements determined by the PND. It is worth mentioning that GPS satellites are generally not geostationary, and are orbiting the earth with various different orbits, and at different speeds. Accordingly, the ephemeris data transmitted at any time is specific to the position of the satellite at the time of transmission, and although the orbits of satellites are quite smooth and thus the location of a satellite can be predicted mathematically given information regarding some earlier position, it is desirable to obtain the most recent ephemeris data from a proximate device as this will result in a more precise location fix.

It is thus possible for the device 500 to quickly ascertain its current position despite receiving only poor GPS signals.

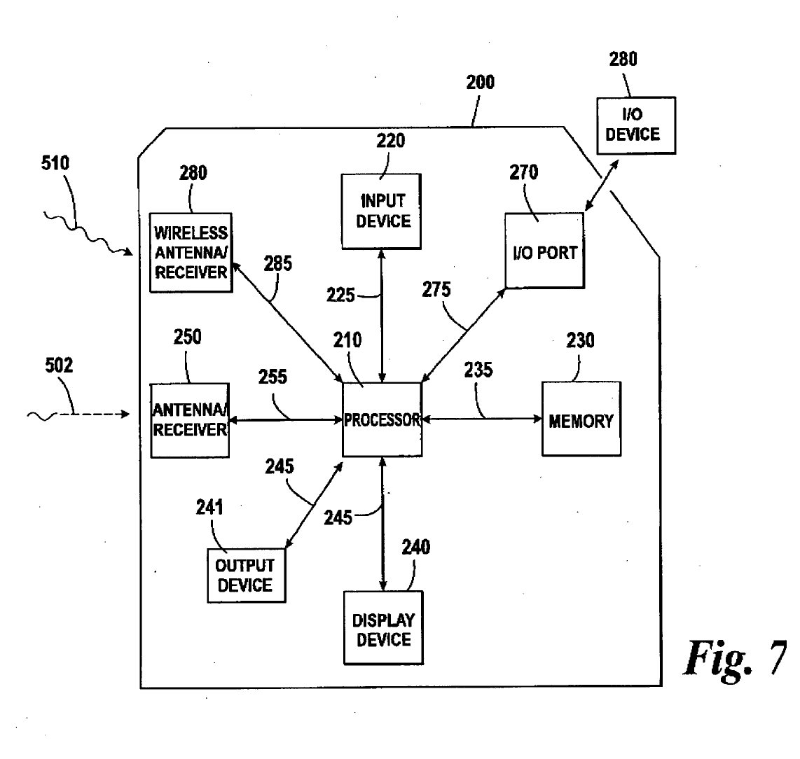

Referring finally to FIG. 8, there is shown the PND of FIG. 2, enhanced by the addition of a wireless (or other telecommunications) antenna/receiver 280 by means of which data signals can be received and transmitted, such signals subsequently being sent to the processor 210 (or emanating therefrom) via connection 285 inside the device.

1. A method of determining a position of a navigation device, the method comprising the steps of:
receiving a plurality of GPS signals from a plurality of GPS satellites,
determining range information from timing information forming part of said signals, together with identification information, specific to each of said satellites,
attempting to receive and store entire ephemeris data payloads additionally forming part of each said signals and being specific to each of said satellites,
establishing a communication with a proximate device using a wireless communication protocol,
determining whether said proximate device has already stored said ephemeris data, or specific parts thereof, relating to satellite position, for the identified satellites,
requesting and receiving said ephemeris data or specific parts thereof for said identified satellites,
causing said navigation device subsequently to determine its current location using both range information and wirelessly received ephemeris data specific to said satellites for which said range information has been determined.

2. The method according to claim 1, wherein said establishment of a communication with a proximate device, and said subsequent request for and reception of ephemeris data in conditional on a determination that said navigation device cannot completely receive and store said entire ephemeris data payloads for each of said identified satellites.

3. The method according to claim 1, wherein an attempt to establish a communication with a proximate device, and said subsequent request for and reception of ephemeris data from said proximate device occurs concurrently and/or unconditionally as said navigation device is attempting to completely receive and store said entire ephemeris data payloads for each of said identified satellites.

4. The method according to claim 1, further comprising the steps of causing said navigation device, when said navigation device receives satellite signals from more than four satellites, to determine four strongest signals and determine and store range information and identification information only for said four satellites.

5. The method according to claim 4, further comprising the steps of causing said navigation device to, after establishment of communication between said navigation device and proximate device, interrogate said proximate device to determine whether ephemeris data is available for said four identified satellites for which range information is stored on said navigation device, and upon a positive determination thereof, making a request for said ephemeris data specific to said four satellites.

6. The method according to claim 1, wherein said navigation device receives satellite signals using one type of signal transmission or communication protocol, and communicates with said proximate device using a different protocol selected from at least one of the following: GPRS, GSM, CDMA, Bluetooth, Wi-Fi, Wi-Max, UMTS, HSCSD, EDGE, and W-CDMA.

7. The method according to claim 1, wherein said navigation device only requests and receives specific portions of said ephemeris data relating to said identified satellites, said specific portions of data including information representative of positions of said identified satellites.

8. (canceled)

9. (canceled)

10. A navigation system, comprising:
a processor,
a memory,
a graphical display,
a GPS signal antenna,
wherein said antenna is arranged to receive a plurality of GPS signals from a plurality of GPS satellites,
wherein said processor is arranged to determining range information from timing information forming part of said signals, together with identification information, specific to each of said satellites
wherein said memory is arranged to store said information and causing the storing of entire ephemeris data payloads additionally forming part of each said signals and being specific to each of said satellites, and
wherein said system is provided with a second wireless signal transmission and reception means by virtue of which a communication with a proximate device can be established using a wireless communication protocol,
wherein said processor is further arranged to interrogate said proximate device to determining whether said proximate device has already stored said ephemeris data, or specific parts thereof, relating to satellite position for satellites having identification information previously stored in said memory, said processor additionally causing a request signal to be issued and subsequently receiving said ephemeris data or specific parts thereof for said identified satellites by means of which, in conjunction with previously stored range information, said system can determine its current position.
